(19) United States
(12) Patent Application Publication
(10) Pub. No.: US 2020/0084714 A1
(43) Pub. Date: Mar. 12, 2020

(54) Method And Apparatus For Acquiring Channel State Information Reference Resource In Discontinuous Reception

(71) Applicant: MediaTek Singapore Pte. Ltd., Singapore (SG)

(72) Inventors: Abdelkader Medles, Cambridge (GB); Pradeep Jose, Cambridge (GB); Simon George-Kelso, Cambridge (GB)

(21) Appl. No.: 16/565,758

(22) Filed: Sep. 10, 2019

Related U.S. Application Data
(60) Provisional application No. 62/728,890, filed on Sep. 10, 2018.

(51) Int. Cl. H04W 52/02; H04W 76/28; H04W 24/10; H04B 7/06

(52) U.S. Cl. CPC H04W 52/0216; H04B 7/0626; H04W 24/10; H04W 76/28

(57) ABSTRACT

Various solutions for channel state information (CSI) reference resource acquisition in discontinuous reception (DRX) with respect to user equipment and network apparatus in mobile communications are described. An apparatus may receive a DRX configuration. The apparatus may receive a CSI-measurement time configuration. The apparatus may turn on a transceiver to receiver a CSI-reference signal (CSI-RS) according to the CSI-measurement time configuration. The apparatus may perform a CSI reporting or beam management according to the CSI-RS. The CSI-RS may be located in an off duration of the DRX configuration.

### CROSS REFERENCE TO RELATED PATENT APPLICATION(S)

The present disclosure is part of a non-provisional application claiming the priority benefit of U.S. Patent Application No. 62/728,890, filed on 10 Sep. 2018, the content of which is incorporated by reference in its entirety.

### TECHNICAL FIELD

The present disclosure is generally related to mobile communications and, more particularly, to channel state information (CSI) reference resource acquisition in discontinuous reception (DRX) with respect to user equipment and network apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR), CSI is a mechanism that a user equipment (UE) can measure various radio channel quality and report the result to a network node. The network node may transmit/broadcast a reference signal (e.g., CSI-RS) to the UE. The UE may use the CSI-RS for beam management (BM), CSI reporting, mobility management, or radio link monitoring (RLM). Both BM and CSI reporting are performed under the framework of CSI reporting.

NR CSI is based on pseudo random sequence. The sequence needs to be mapped to a set of specific resource elements in resource grid. The network node needs to allocate reference resources to transmit the CSI-RS. In current regulations, CSI-RS reference resources for CSI reporting must be in the DRX active time in a downlink slot. In view of the current regulations, there should be at least one CSI-RS transmission occasion for channel measurement and CSI-RS and/or CSI-interference measurement (CSI-IM) occasion for interference measurement in DRX active time. If there is no valid downlink slot for the CSI reference resource corresponding to a CSI report setting in a serving cell, CSI reporting is omitted for the serving cell in uplink slot n.

For BM purpose, it makes sense for the network to share CSI-RS resources among a plurality of UEs to reduce network overhead and improve efficiency. This will cause a high burden on the network. Thus, periodic or semi-static CSI-RS resource use is required to lower the burden both on term of overhead/efficiency and layer 1 signalling for BM. Depending on the system configuration, the use of periodic shared CSI-RS resources for CSI reporting could be also advantageous to reduce the system overhead.

When shared periodic CSI-RS resources are used with DRX, some UEs may not be able to receive the CSI-RS on their DRX on duration. Accordingly, the current the framework of CSI-RS and CSI reporting need to be improved. Therefore, it is needed to provide proper CSI reference resource acquisition schemes in DRX for considering both power saving and CSI reporting.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to CSI reference resource acquisition in DRX with respect to user equipment and network apparatus in mobile communications.

In one aspect, a method may involve an apparatus receiving a DRX configuration. The method may also involve the apparatus receiving a CSI-measurement time configuration. The method may further involve the apparatus turning on a transceiver to receiver a CSI-RS according to the CSI-measurement time configuration. The method may further involve the apparatus performing a CSI reporting or beam management according to the CSI-RS. The CSI-RS may be located in an off duration of the DRX configuration.

In one aspect, a method may involve an apparatus receiving a DRX configuration. The method may also involve the apparatus turning on a transceiver to receiver a control signal in an off duration of the DRX configuration. The method may further involve the apparatus receiving a CSI-RS while turning on the transceiver in the off duration of the DRX configuration. The method may further involve the apparatus performing a CSI reporting or beam management according to the CSI-RS. The CSI-RS may be located within a same slot as the control signal or within an interval earlier or later than the control signal.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving a DRX configuration. The processor may also perform operations comprising receiving, via the transceiver, a CSI-measurement time configuration. The processor may further perform operations comprising turning on the transceiver to receiver a CSI-RS according to the CSI-measurement time configuration. The processor may further perform operations comprising performing a CSI reporting or beam management according to the CSI-RS. The CSI-RS may be located in an off duration of the DRX configuration.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving a DRX configuration. The processor may also perform operations comprising turning on the transceiver to receiver a control signal in an off duration of the DRX configuration. The processor may further perform operations comprising receiving, via the transceiver, a CSI-RS while turning on the transceiver in the off duration of the DRX configuration. The processor may further perform operations comprising performing a CSI reporting or beam management according to the CSI-RS. The CSI-RS may be located within a same slot as the control signal or within an interval earlier or later than the control signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication apparatus and an example network apparatus in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Overview

Implementations in accordance with the present disclosure relate to various techniques, methods, schemes and/or solutions pertaining to CSI reference resource acquisition in DRX with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In LTE or NR, CSI is a mechanism that a UE can measure various radio channel quality and report the result to a network node. The network node may transmit/broadcast a reference signal (e.g., CSI-RS) to the UE. The UE may use the CSI-RS for BM, CSI reporting, mobility management, or RLM. Both BM and CSI reporting are performed under the framework of CSI reporting.

NR CSI is based on pseudo random sequence. The sequence needs to be mapped to a set of specific resource elements in resource grid. The network node needs to allocate reference resources to transmit the CSI-RS. In current regulations, CSI-RS reference resources for CSI reporting must be in the DRX active time in a downlink slot. In view of the current regulations, there should be at least one CSI-RS transmission occasion for channel measurement and CSI-RS and/or CSI-IM occasion for interference measurement in DRX active time. If there is no valid downlink slot for the CSI reference resource corresponding to a CSI report setting in a serving cell, CSI reporting is omitted for the serving cell in uplink slot n.

For BM purpose, it makes sense for the network to share CSI-RS resources among a plurality of UEs to reduce network overhead and improve efficiency. This will cause a high burden on the network. Thus, periodic or semi-static CSI-RS resource use is required to lower the burden both on term of overhead/efficiency and layer 1 signalling for BM. Depending on the system configuration, the use of periodic shared CSI-RS resources for CSI reporting could be also advantageous to reduce the system overhead.

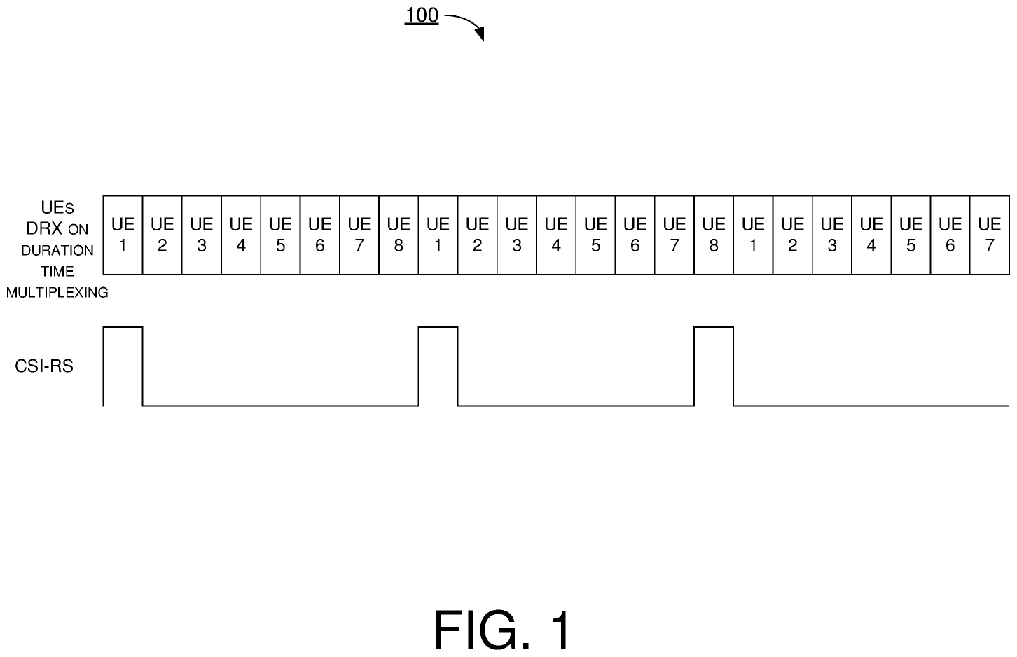

When shared periodic CSI-RS resources are used with DRX, some UEs may not be able to receive the CSI-RS on their DRX on duration. FIG. 1 illustrates an example scenario 100 under schemes in accordance with implementations of the present disclosure. Scenario 100 involves a plurality of UEs and a network node, which may be a part of a wireless communication network (e.g., an LTE network, an LTE-Advanced network, an LTE-Advanced Pro network, a 5G network, an NR network, an IoT network or an NB-IoT network). In scenario 100, UE 1 will receive CSI-RS on the on duration, but UEs 2 to 8 will not be able to receive the periodic CSI-RS resources in the on duration. This is due to that the network node need to time multiplex the DRX on duration of multiple UEs. Therefore, some UEs may not have chances to receive CSI-RS during their DRX on durations and may not be able to perform BM or CSI reporting accordingly.

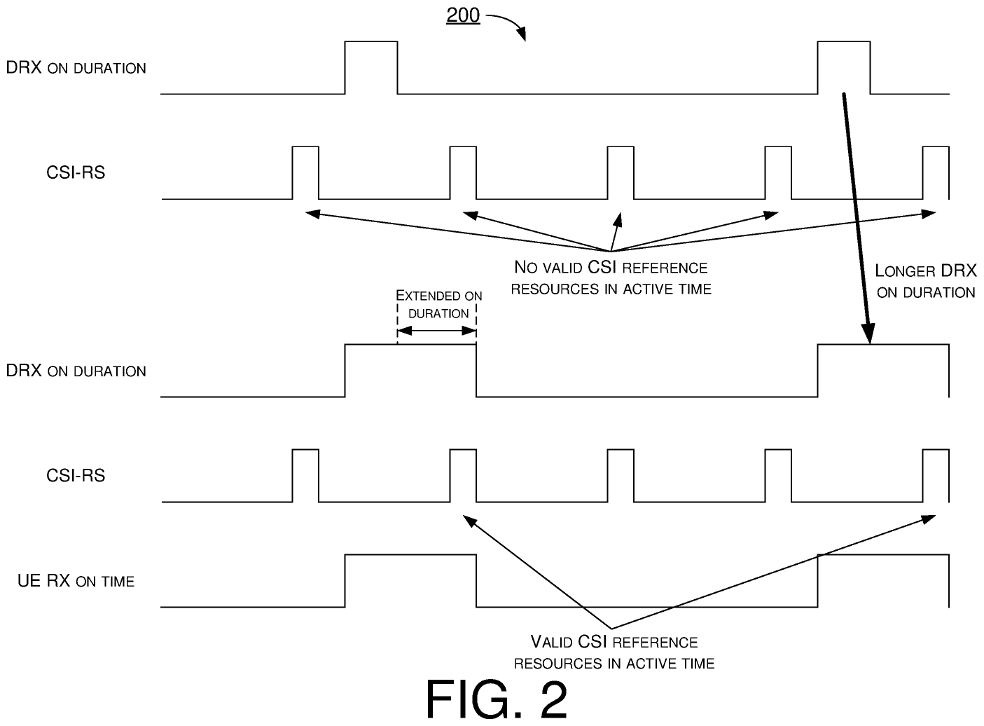

With current definition of the CSI reference resources “there is at least one CSI-RS transmission occasion for channel measurement and CSI-RS and/or CSI-IM occasion for interference measurement in DRX active time”, the network must configure very long DRX on duration to guarantee that the UE receives valid periodic CSI-RS reference resources. FIG. 2 illustrates an example scenario 200 under schemes in accordance with implementations of the present disclosure. Scenario 200 involves a UE and a network node, which may be a part of a wireless communication network (e.g., an LTE network, an LTE-Advanced network, an LTE-Advanced Pro network, a 5G network, an NR network, an IoT network or an NB-IoT network). In order to receive the CSI-RS, the network node needs to configure longer DRX on duration to the UE for receiving the CSI reference resources. Thus, the CSI-RS located within the extended DRX on duration may be consider as a valid CSI reference resource.

For a DRX cycle of P_DRX (e.g. 80 ms), CSI-RS period of P_CSIRS (e.g. 40 ms) with P_DRX≥P_CSIRS, and CSI-RS to DRX on duration offset L (e.g. 5 ms), the DRX on duration has to be at least (e.g., P_CSIRS−L)=35 ms to guarantee a valid periodic CSI-RS reference resource. Considering a typical DRX on duration of about 5 ms to 10 ms, the required DRX on duration of 35 ms is 3 to 7 times of the typical setting leading to a similar UE power consumption increase. Given that on duration of UEs are typically time multiplexed, therefore the required DRX on duration (e.g., P_CSIRS−L) value is uniformly spread over the interval 0 to P_CSIRS in an event that P_DRX P_CSIRS and some users will suffer larger power hit than others.

To remove or reduce the power consumption due to increased DRX on duration, the current regulations and the CSI reporting framework need to be improved. In view of the above, the present disclosure proposes a number of schemes pertaining to CSI reference resource acquisition in DRX with respect to the UE and the network apparatus. According to the schemes of the present disclosure, a new CSI-measurement time configuration in DRX may be defined. The CSI-RS/CSI-IM resources that fall within the CSI-measurement time configuration are considered to be valid reference resources. Alternatively, the CSI-RS/CSI-IM resources which are time co-located or in the proximity of the serving cell synchronization signal block (SSB) or tracking reference signal (TRS) may be considered as valid reference resources. Alternatively, the CSI-RS/CSI-IM resources which are time co-located or in the proximity of the serving cell SSB measurement timing configuration (SMTC) may be considered as valid reference resources.

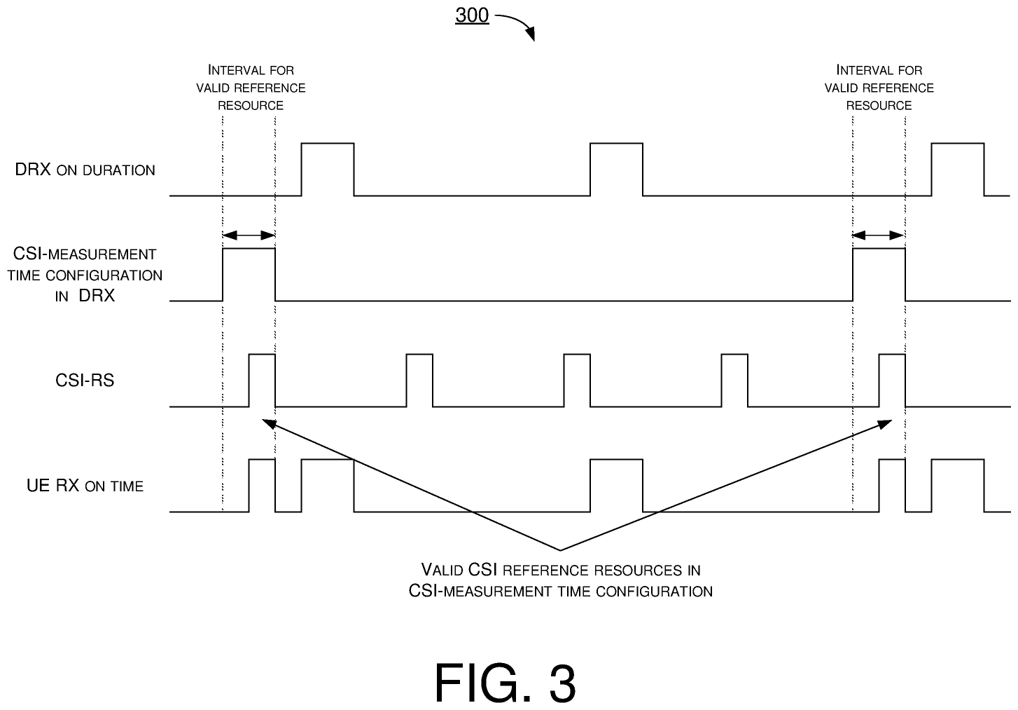

FIG. 3 illustrates an example scenario 300 under schemes in accordance with implementations of the present disclosure. Scenario 300 involves a UE and a network node, which may be a part of a wireless communication network (e.g., an LTE network, an LTE-Advanced network, an LTE-Advanced Pro network, a 5G network, an NR network, an IoT network or an NB-IoT network). A new CSI-measurement time configuration in DRX may be defined. The CSI-measurement time configuration may be used to configure additional active time (e.g., on duration) for the UE to turn on its transceiver and receive reference signals. The CSI reference resources that fall within the CSI-measurement time configuration may be considered to be valid reference resources. The CSI reference resources may comprise CSI-RS and CSI-IM resources. With this solution, the CSI-RS/CSI-IM resources that falls within CSI-measurement time configuration and/or within the DRX active time are considered to be valid CSI-RS/CSI-IM resources for BM/CSI reporting.

Specifically, the UE may be configured to receive a DRX configuration. The DRX configuration may configure some off durations for UE power saving. The UE may be in a dormant state when configured with the DRX configuration. However, the CSI-RS/CSI-IM resources may be located in the off duration of the DRX configuration. The UE may have no changes to receive the CSI-RS/CSI-IM resources. Thus, the UE may be configured to further receive a CSI-measurement time configuration. The CSI-measurement time configuration may be used to configure additional active time (e.g., on duration) for the UE to receive the CSI-RS/CSI-IM resources. The active time of the CSI-measurement time configuration may be equal to or greater than the duration of the CSI-RS/CSI-IM resources. The CSI-measurement time configuration may provide additional chances for the UE to receive the CSI-RS/CSI-IM resources. The UE may be configured to turn on the transceiver to receiver the CSI-RS/CSI-IM according to the CSI-measurement time configuration. For example, the UE may receive the CSI-RS/CSI-IM resources located in the active time of the CSI-measurement time configuration even in an event that the CSI-RS/CSI-IM resources are located in the off duration of the DRX configuration. The UE may be configured to perform a CSI reporting or beam management according to the received CSI-RS/CSI-IM resources.

Accordingly, the UE may still be able to save power in view of the DRX configuration and can perform the CSI reporting or beam management according to the CSI-measurement time configuration. The proposed solution may allow the network to control where the UE does wake-up to acquire CSI-RS/CSI-IM resources during DRX inactive time, and hence achieve a compromise between power consumption and system performance.

In some implementation, the UE may be configured to determine that a periodic or semi-static CSI reference resource located within the CSI-measurement time configuration is a valid reference resource. Alternatively, the UE may be configured to determine that a periodic or semi-static CSI reference resource located within either the CSI-measurement time configuration or an on duration of the DRX configuration is a valid reference resource. The UE may be configured to perform the CSI reporting or beam management according to the periodic or semi-static CSI reference resource.

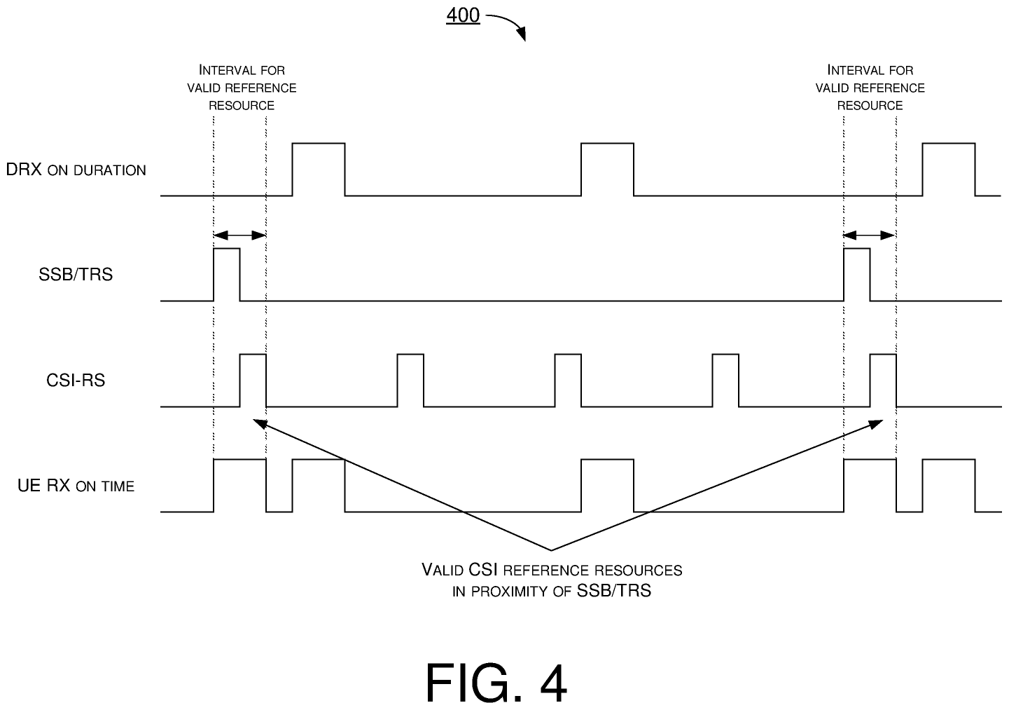

FIG. 4 illustrates an example scenario 400 under schemes in accordance with implementations of the present disclosure. Scenario 400 involves a UE and a network node, which may be a part of a wireless communication network (e.g., an LTE network, an LTE-Advanced network, an LTE-Advanced Pro network, a 5G network, an NR network, an IoT network or an NB-IoT network). The CSI-RS/CSI-IM resources which are time co-located or in the proximity of the serving cell control signal may be considered as valid reference resources. The control signal may comprise at least one of a synchronization signal block (SSB) and a tracking reference signal (TRS). Since the UE needs to wake up to receive the control signal (e.g., SSB/TRS), the UE may incidentally receive the CSI-RS/CSI-IM resources co-located or near the control signal. The UE may receive both the control signal and the CSI-RS/CSI-IM while turning on its transceiver. With this solution, the UE may consider the CSI-RS/CSI-IM resources for BM/CSI reporting that are transmitted within the same slots as the SSB and/or TRS, or within an interval earlier or later than the SSB and/or TRS as the valid reference resources. The interval may comprise one or more slots or a period of time (e.g., millisecond). The length of the interval may comprise a fixed value, a predetermined value, or a radio resource control (RRC) configured value. The length of the interval may also be a value defined in the 3rd Generation Partnership Project (3GPP) specifications. Which reference to use the SSB, TRS, or SSB and TRS may be either defined in the 3GPP specification or RRC signalled.

Specifically, the UE may be configured to receive a DRX configuration. The DRX configuration may configure some off durations for UE power saving. The UE may be in a dormant state when configured with the DRX configuration. The CSI-RS/CSI-IM resources may be located in the off duration of the DRX configuration. The UE may have no changes to receive the CSI-RS/CSI-IM resources. However, the UE may be configured to turn on a transceiver to receiver a control signal in an off duration of the DRX configuration. The UE may further be configured to receive the CSI-RS while turning on the transceiver in the off duration of the DRX configuration. The CSI-RS may be located within a same slot as the control signal or within an interval earlier or later than the control signal. The turn on duration for receiving the control signal may provide additional chances for the UE to receive the CSI-RS/CSI-IM resources. The UE may take the opportunities to receive the CSI-RS while turning on its transceiver for receiving the control signals. The turn on duration of the transceiver may be equal to or greater than the duration of the control signal and the CSI-RS/CSI-IM resources. The UE may be configured to determine that a periodic or semi-static CSI reference resource located within the same slot as the control signal or within the interval is a valid reference resource. Thus, the UE may perform a CSI reporting or beam management according to the received CSI-RS.

Accordingly, the UE may still be able to save power in view of the DRX configuration and can perform the CSI reporting or beam management according to the additional on duration for the control signals. The proposed solution may lead to a reduced receiver (RX) on time and power saving, especially since that the UE will wake-up for SSB/TRS reception anyway to perform synchronisation. In a case that the CSI-RS/CS-IM resources are co-located in time with the SSB/TRS, no additional RX on time is required at all.

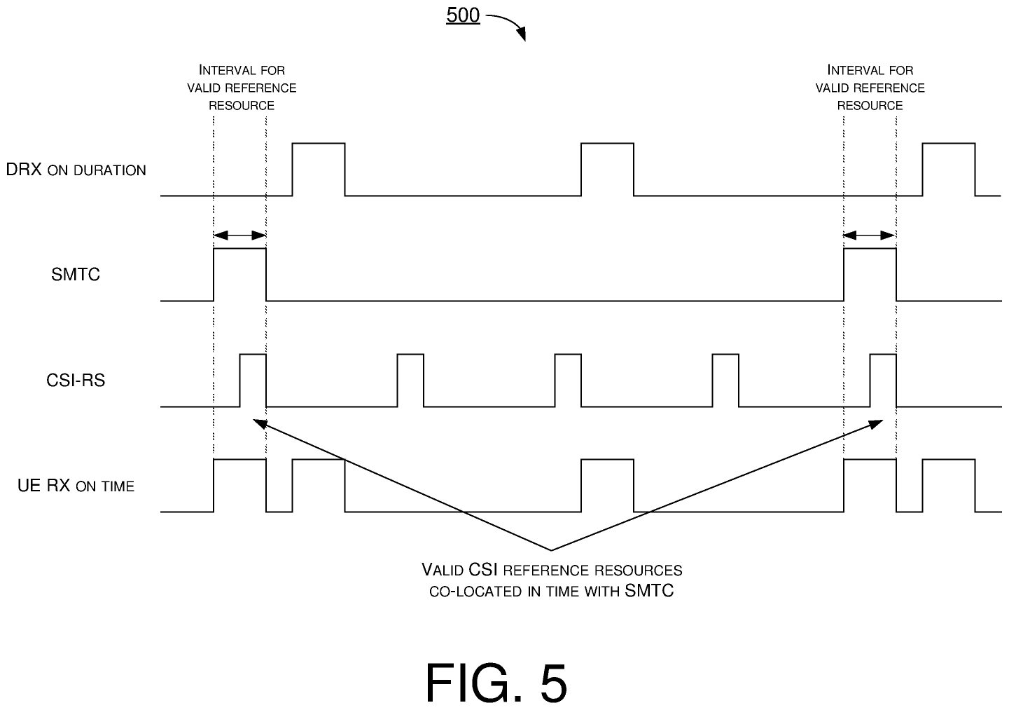

FIG. 5 illustrates an example scenario 500 under schemes in accordance with implementations of the present disclosure. Scenario 500 involves a UE and a network node, which may be a part of a wireless communication network (e.g., an LTE network, an LTE-Advanced network, an LTE-Advanced Pro network, a 5G network, an NR network, an IoT network or an NB-IoT network). The CSI-RS/CSI-IM resources which are time co-located or in the proximity of the serving cell control signal may be considered as valid reference resources. The control signal may comprise an SSB measurement timing configuration (SMTC). Since the UE needs to wake up to receive the SMTC, the UE may incidentally receive the CSI-RS/CSI-IM resources co-located or near the SMTC. The UE may receive both the SMTC and the CSI-RS/CSI-IM while turning on its transceiver. With this solution, the UE may consider the CSI-RS/CSI-IM resources for BM/CSI reporting that are transmitted within the same slots as the SMTC, or within an interval earlier or later than the SMTC as the valid reference resources. The interval may comprise one or more slots or a period of time (e.g., millisecond). The length of the interval may comprise a fixed value, a predetermined value, or an RRC configured value. The length of the interval may also be a value defined in the 3GPP specifications. Which reference to use the SMTC1, SMTC2, or both SMTC1 and SMTC2 may be either defined in the 3GPP specification or RRC signalled.

Similarly, the UE may be configured to receive a DRX configuration. The DRX configuration may configure some off durations for UE power saving. The UE may be in a dormant state when configured with the DRX configuration. The CSI-RS/CSI-IM resources may be located in the off duration of the DRX configuration. The UE may have no changes to receive the CSI-RS/CSI-IM resources. However, the UE may be configured to turn on a transceiver to receiver the SMTC in an off duration of the DRX configuration. The UE may further be configured to receive the CSI-RS while turning on the transceiver in the off duration of the DRX configuration. The CSI-RS may be located within a same slot as the SMTC or within an interval earlier or later than the SMTC. The turn on duration for receiving the SMTC may provide additional chances for the UE to receive the CSI-RS/CSI-IM resources. The UE may take the opportunities to receive the CSI-RS while turning on its transceiver for receiving the SMTC. The turn on duration of the transceiver may be equal to or greater than the duration of the SMTC and the CSI-RS/CSI-IM resources. The UE may be configured to determine that a periodic or semi-static CSI reference resource located within the same slot as the SMTC or within the interval is a valid reference resource. Thus, the UE may perform a CSI reporting or beam management according to the received CSI-RS.

Accordingly, the UE may still be able to save power in view of the DRX configuration and can perform the CSI reporting or beam management according to the additional on duration for the SMTC. The proposed solution may lead to a reduced RX on time and power saving, especially since that the UE will wake-up for SMTC reception anyway for radio resource management (RRM). In a case that the CSI-RS/CS-IM resources are co-located in time with the SMTC, no additional RX on time is required at all.

In some implementations, similar concept may be used for BM and CSI reporting of secondary cells (SCells) in dormant state where the UE performs BM/CSI reporting in addition to RRM. In those cases, the UE may determine valid reference resources according to the solutions described in scenario 300, 400 and 500 for dormant SCells. For dormant state, in addition to RRM, SSB reception and BM/CSI reporting functionalities enabled, the tracking reference signal (TRS) processing may also be enabled as well. The same concept of dormant SCell may be extended to dormant bandwidth part (BWP). The BM/CSI reporting as well as the TRS processing may be enabled for dormant BWP. The UE may determine valid reference resources according to the solutions described in scenario 300, 400 and 500 for dormant BWP.

### Illustrative Implementations

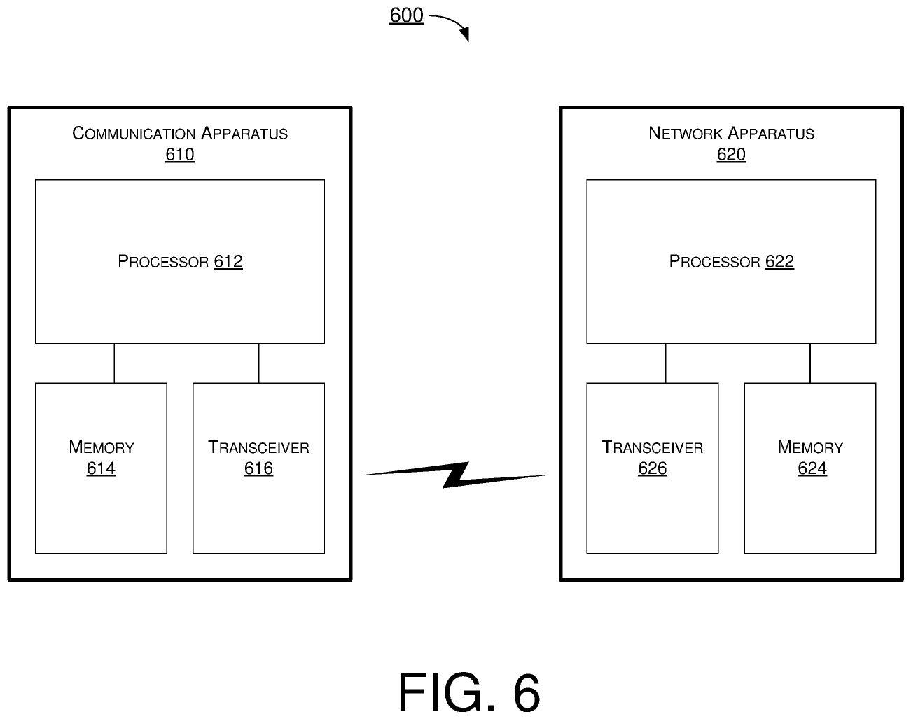

FIG. 6 illustrates an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to CSI reference resource acquisition in DRX with respect to user equipment and network apparatus in wireless communications, including scenarios 300, 400 and 500 described above as well as processes 700 and 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT or NB-IoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a base station, a small cell, a router or a gateway. For instance, network apparatus 620 may be implemented in an eNodeB in an LTE, LTE-Advanced or LTE-Advanced Pro network or in a gNB in a 5G, NR, IoT or NB-IoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more RISC or CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including power consumption reduction in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, a new CSI-measurement time configuration in DRX may be defined. Processor 622 may use the CSI-measurement time configuration to configure additional active time (e.g., on duration) for communication apparatus 610 to turn on transceiver 616 and receive reference signals. Processor 612 may consider the CSI reference resources that fall within the CSI-measurement time configuration as valid reference resources. The CSI reference resources may comprise CSI-RS and CSI-IM resources. With this solution, processor 612 may consider the CSI-RS/CSI-IM resources that falls within CSI-measurement time configuration and/or within the DRX active time as valid CSI-RS/CSI-IM resources for BM/CSI reporting.

In some implementations, processor 612 may be configured to receive, via transceiver 616, a DRX configuration. Processor 622 may use the DRX configuration to configure some off durations for power saving at communication apparatus 610. Processor 612 may be in a dormant state when configured with the DRX configuration. However, the CSI-RS/CSI-IM resources may be located in the off duration of the DRX configuration. Processor 612 may have no changes to receive the CSI-RS/CSI-IM resources. Thus, processor 612 may be configured to further receive, via transceiver 616, a CSI-measurement time configuration. Processor 622 may use the CSI-measurement time configuration to configure additional active time (e.g., on duration) for communication apparatus 610 to receive the CSI-RS/CSI-IM resources. Processor 622 may configure the active time of the CSI-measurement time configuration to be equal to or greater than the duration of the CSI-RS/CSI-IM resources. The CSI-measurement time configuration may provide additional chances for communication apparatus 610 to receive the CSI-RS/CSI-IM resources. Processor 612 may be configured to turn on transceiver 616 to receiver the CSI-RS/CSI-IM according to the CSI-measurement time configuration. For example, processor 612 may receive the CSI-RS/CSI-IM resources located in the active time of the CSI-measurement time configuration even in an event that the CSI-RS/CSI-IM resources are located in the off duration of the DRX configuration. Processor 612 may be configured to perform a CSI reporting or beam management according to the received CSI-RS/CSI-IM resources.

In some implementations, processor 612 may be configured to determine that a periodic or semi-static CSI reference resource located within the CSI-measurement time configuration is a valid reference resource. Alternatively, processor 612 may be configured to determine that a periodic or semi-static CSI reference resource located within either the CSI-measurement time configuration or an on duration of the DRX configuration is a valid reference resource. Processor 612 may be configured to perform the CSI reporting or beam management according to the periodic or semi-static CSI reference resource.

In some implementations, processor 612 may consider the CSI-RS/CSI-IM resources which are time co-located or in the proximity of the serving cell control signal as valid reference resources. The control signal may comprise at least one of an SSB and a TRS. Since processor 612 needs to wake up to receive the control signal (e.g., SSB/TRS), processor 612 may incidentally receive the CSI-RS/CSI-IM resources co-located or near the control signal. Processor 612 may receive both the control signal and the CSI-RS/CSI-IM while turning on transceiver 616. With this solution, processor 612 may consider the CSI-RS/CSI-IM resources for BM/CSI reporting that are transmitted within the same slots as the SSB and/or TRS, or within an interval earlier or later than the SSB and/or TRS as the valid reference resources.

In some implementations, processor 612 may be configured to receive, via transceiver 616, a DRX configuration. Processor 622 may use the DRX configuration to configure some off durations for power saving at communication apparatus 610. Processor 612 may be in a dormant state when configured with the DRX configuration. The CSI-RS/CSI-IM resources may be located in the off duration of the DRX configuration. Processor 612 may have no changes to receive the CSI-RS/CSI-IM resources. However, processor 612 may be configured to turn on transceiver 616 to receiver a control signal in an off duration of the DRX configuration. Processor 612 may further be configured to receive the CSI-RS while turning on transceiver 616 in the off duration of the DRX configuration. The CSI-RS may be located within a same slot as the control signal or within an interval earlier or later than the control signal. The turn on duration for receiving the control signal may provide additional chances for communication apparatus 610 to receive the CSI-RS/CSI-IM resources. Processor 612 may take the opportunities to receive the CSI-RS while turning on transceiver 616 for receiving the control signals. The turn on duration of transceiver 616 may be equal to or greater than the duration of the control signal and the CSI-RS/CSI-IM resources. Processor 612 may be configured to determine that a periodic or semi-static CSI reference resource located within the same slot as the control signal or within the interval is a valid reference resource. Thus, processor 612 may perform a CSI reporting or beam management according to the received CSI-RS.

In some implementations, processor 612 may consider the CSI-RS/CSI-IM resources which are time co-located or in the proximity of the serving cell control signal as valid reference resources. The control signal may comprise an SMTC. Since processor 612 needs to wake up to receive the SMTC, processor 612 may incidentally receive the CSI-RS/CSI-IM resources co-located or near the SMTC. Processor 612 may receive both the SMTC and the CSI-RS/CSI-IM while turning on transceiver 616. With this solution, processor 612 may consider the CSI-RS/CSI-IM resources for BM/CSI reporting that are transmitted within the same slots as the SMTC, or within an interval earlier or later than the SMTC as the valid reference resources.

In some implementations, processor 612 may be configured to receive, via transceiver 616, a DRX configuration. Processor 622 may use the DRX configuration to configure some off durations for power saving at communication apparatus 610. Processor 612 may be in a dormant state when configured with the DRX configuration. The CSI-RS/CSI-IM resources may be located in the off duration of the DRX configuration. Processor 612 may have no changes to receive the CSI-RS/CSI-IM resources. However, processor 612 may be configured to turn on transceiver 616 to receiver the SMTC in an off duration of the DRX configuration. Processor 612 may further be configured to receive the CSI-RS while turning on transceiver 616 in the off duration of the DRX configuration. The CSI-RS may be located within a same slot as the SMTC or within an interval earlier or later than the SMTC. The turn on duration for receiving the SMTC may provide additional chances for processor 612 to receive the CSI-RS/CSI-IM resources. Processor 612 may take the opportunities to receive the CSI-RS while turning on transceiver 616 for receiving the SMTC. The turn on duration of transceiver 616 may be equal to or greater than the duration of the SMTC and the CSI-RS/CSI-IM resources. Processor 612 may be configured to determine that a periodic or semi-static CSI reference resource located within the same slot as the SMTC or within the interval is a valid reference resource. Thus, processor 612 may perform a CSI reporting or beam management according to the received CSI-RS.

Illustrative Processes

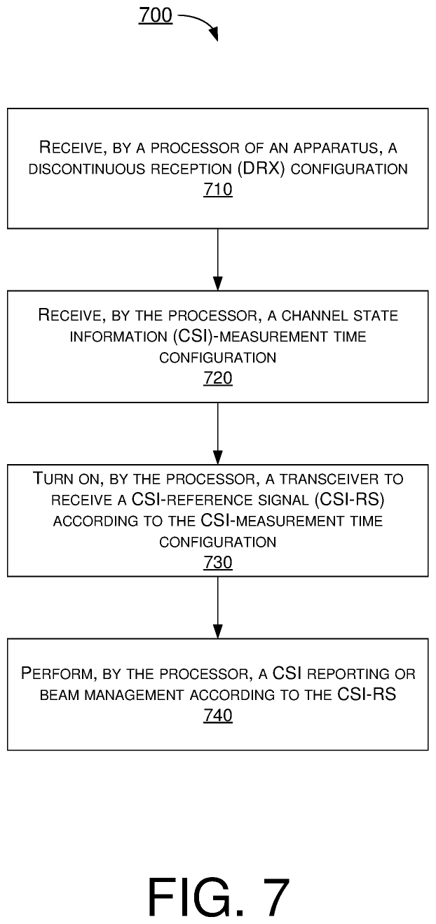

FIG. 7 illustrates an example process 700 in accordance with an implementation of the present disclosure. Process 700 may be an example implementation of above scenarios, whether partially or completely, with respect to CSI reference resource acquisition in DRX with the present disclosure. Process 700 may represent an aspect of implementation of features of communication apparatus 610. Process 700 may include one or more operations, actions, or functions as illustrated by one or more of blocks 710, 720, 730 and 740. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At 710, process 700 may involve processor 612 of apparatus 610 receiving a DRX configuration. Process 700 may proceed from 710 to 720.

At 720, process 700 may involve processor 612 receiving a CSI-measurement time configuration. Process 700 may proceed from 720 to 730.

At 730, process 700 may involve processor 612 turning on a transceiver to receiver a CSI-RS according to the CSI-measurement time configuration. Process 700 may proceed from 730 to 740.

At 740, process 700 may involve processor 612 performing a CSI reporting or beam management according to the CSI-RS. The CSI-RS may be located in an off duration of the DRX configuration.

In some implementations, process 700 may involve processor 612 determining that a periodic or semi-static CSI reference resource located within the CS I-measurement time configuration is a valid reference resource.

In some implementations, process 700 may involve processor 612 determining that a periodic or semi-static CSI reference resource located within either the CSI-measurement time configuration or an on duration of the DRX configuration is a valid reference resource.

In some implementations, processor 612 may be configured in a dormant state.

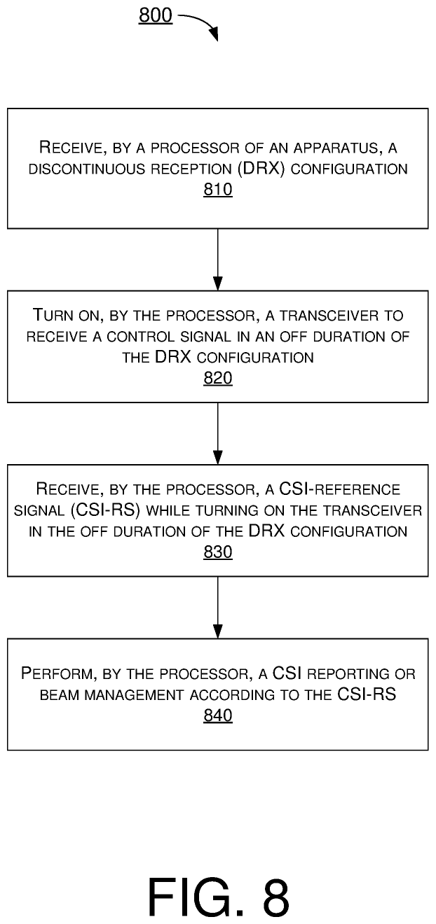

FIG. 8 illustrates an example process 800 in accordance with an implementation of the present disclosure. Process 800 may be an example implementation of above scenarios, whether partially or completely, with respect to CSI reference resource acquisition in DRX with the present disclosure. Process 800 may represent an aspect of implementation of features of communication apparatus 610. Process 800 may include one or more operations, actions, or functions as illustrated by one or more of blocks 810, 820, 830 and 840. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may be implemented by communication apparatus 610 or any suitable UE or machine type devices. Solely for illustrative purposes and without limitation, process 800 is described below in the context of communication apparatus 610. Process 800 may begin at block 810.

At 810, process 800 may involve processor 612 of apparatus 610 receiving a DRX configuration. Process 800 may proceed from 810 to 820.

At 820, process 800 may involve processor 612 turning on a transceiver to receiver a control signal in an off duration of the DRX configuration. Process 800 may proceed from 820 to 830.

At 830, process 800 may involve processor 612 receiving a CSI-RS while turning on the transceiver in the off duration of the DRX configuration. Process 800 may proceed from 830 to 840.

At 840, process 800 may involve processor 612 performing a CSI reporting or beam management according to the CSI-RS. The CSI-RS may be located within a same slot as the control signal or within an interval earlier or later than the control signal.

In some implementations, the control signal may comprise at least one of an SSB, a TRS, and an SMTC.

In some implementations, the interval may comprise one or more slots or a time period.

In some implementations, a length of the interval may comprise a fixed value, a predetermined value, or an RRC configured value.

In some implementations, process 800 may involve processor 612 determining that a periodic or semi-static CSI reference resource located within the same slot as the control signal or within the interval is a valid reference resource.

In some implementations, processor 612 may be configured in a dormant state.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a discontinuous reception (DRX) configuration;
receiving, by the processor, a channel state information (CSI)-measurement time configuration;
turning on, by the processor, a transceiver to receiver a CSI-reference signal (CSI-RS) according to the CSI-measurement time configuration; and
performing, by the processor, a CSI reporting or beam management according to the CSI-RS,
wherein the CSI-RS is located in an off duration of the DRX configuration.

2. The method of claim 1, further comprising:
determining, by the processor, that a periodic or semi-static CSI reference resource located within the CSI-measurement time configuration is a valid reference resource.

3. The method of claim 1, further comprising:
determining, by the processor, that a periodic or semi-static CSI reference resource located within either the CSI-measurement time configuration or an on duration of the DRX configuration is a valid reference resource.

4. The method of claim 1, wherein the processor is configured in a dormant state.

5. A method, comprising:
receiving, by a processor of an apparatus, a discontinuous reception (DRX) configuration;
turning on, by the processor, a transceiver to receiver a control signal in an off duration of the DRX configuration;
receiving, by the processor, a CSI-reference signal (CSI-RS) while turning on the transceiver in the off duration of the DRX configuration; and
performing, by the processor, a CSI reporting or beam management according to the CSI-RS,
wherein the CSI-RS is located within a same slot as the control signal or within an interval earlier or later than the control signal.

6. The method of claim 5, wherein the control signal comprises at least one of a synchronization signal block (SSB), a tracking reference signal (TRS), and an SSB measurement timing configuration (SMTC).

7. The method of claim 5, wherein the interval comprises one or more slots or a time period.

8. The method of claim 5, wherein a length of the interval comprises a fixed value, a predetermined value, or a radio resource control (RRC) configured value.

9. The method of claim 5, further comprising:
determining, by the processor, that a periodic or semi-static CSI reference resource located within the same slot as the control signal or within the interval is a valid reference resource.

10. The method of claim 5, wherein the processor is configured in a dormant state.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a discontinuous reception (DRX) configuration;
receiving, via the transceiver, a channel state information (CSI)-measurement time configuration;
turning on the transceiver to receiver a CSI-reference signal (CSI-RS) according to the CSI-measurement time configuration; and
performing a CSI reporting or beam management according to the CSI-RS,
wherein the CSI-RS is located in an off duration of the DRX configuration.

12. The apparatus of claim 11, wherein, during operation, the processor further performs operations comprising:
determining that a periodic or semi-static CSI reference resource located within the CSI-measurement time configuration is a valid reference resource.

13. The apparatus of claim 11, wherein, during operation, the processor further performs operations comprising:
determining that a periodic or semi-static CSI reference resource located within either the CSI-measurement time configuration or an on duration of the DRX configuration is a valid reference resource.

14. The apparatus of claim 11, wherein the processor is configured in a dormant state.

15. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a discontinuous reception (DRX) configuration;
turning on the transceiver to receiver a control signal in an off duration of the DRX configuration;
receiving, via the transceiver, a CSI-reference signal (CSI-RS) while turning on the transceiver in the off duration of the DRX configuration; and
performing a CSI reporting or beam management according to the CSI-RS,
wherein the CSI-RS is located within a same slot as the control signal or within an interval earlier or later than the control signal.

16. The apparatus of claim 15, wherein the control signal comprises at least one of a synchronization signal block (SSB), a tracking reference signal (TRS), and an SSB measurement timing configuration (SMTC).

17. The apparatus of claim 15, wherein the interval comprises one or more slots or a time period.

18. The apparatus of claim 15, wherein a length of the interval comprises a fixed value, a predetermined value, or a radio resource control (RRC) configured value.

19. The apparatus of claim 15, wherein, during operation, the processor further performs operations comprising:
determining that a periodic or semi-static CSI reference resource located within the same slot as the control signal or within the interval is a valid reference resource.

20. The apparatus of claim 15, wherein the processor is configured in a dormant state.
